(19) United States
(12) Patent Application Publication
(10) Pub. No.: US 2026/0226928 A1
(43) Pub. Date: Aug. 6, 2026

(54) T-Channel Speed Clamp

(71) Applicant: Eric Berube, Ardrossan (CA)

(72) Inventor: Eric Berube, Ardrossan (CA)

(73) Assignee: Radius Tools Inc., Ardrossan (CA)

(21) Appl. No.: 19/044,250

(22) Filed: Feb. 3, 2025

(51) Int. Cl. F16B 2/12

(52) U.S. Cl. CPC F16B 2/12

(57) ABSTRACT

A t-channel speed clamp has a jaw assembly that moves inclined linearly relative to the base. A clamping knob is used transversely to secure the base to the work surface and advance the jaw toward the workpiece. The mechanism is comprised of (a) one or more springs to sequence the clamping force of the base to the work surface prior to initiating the clamping force of the jaw on the workpiece and (b) the jaw engages the workpiece either perpendicular or parallel to the work surface, exerting both vertical and horizontal force components on the workpiece.

### FIELD OF THE INVENTION

The present invention relates to clamps used in conjunction with T-channel, typically for holding a workpiece.

### BACKGROUND OF THE INVENTION

In many machine operations, it is desired to secure the workpiece to the work surface. T-channel built into the work surface, used in conjunction with some form of clamping device, is commonly used for this. These clamps may secure the workpiece from the side or the top. Clamping from the top can be efficiently achieved. However, it obstructs that area of the workpiece from the machining operation. Clamping from the side requires first securing the clamp to the work surface, and then applying the clamping force to the workpiece.

Accordingly, when efficiency is desired, there is a need in the art for a clamp that can apply the workpiece and work surface clamping force simultaneously.

### SUMMARY OF THE INVENTION

The present invention is a T-channel mounted clamp that can be expediently positioned along the channel, linearly and rotationally. In one aspect, the invention comprises a jaw assembly and a base, wherein the jaw may move toward the workpiece slidably mounted to the base along an inclined planer surface. In one embodiment a manually operable clamping knob is used to simultaneously affix the base to the work surface and advance the jaw toward the workpiece. A plurality of springs provides resistance to the jaw movement to prioritize the base-to-work surface affixing.

In one embodiment the jaw has two surfaces that can grip the workpiece. The primary gripping surface is perpendicular to the work surface while the secondary gripping surface is parallel to the work surface. Using the primary jaw gripping surface facilitates an unobstructed top workpiece surface. In one embodiment using the secondary jaw gripping surface is preferable for clamping thin material.

An embodiment that requires a lower overall height would substitute the actuating knob (18) with a lower profile threaded element, such as a hex nut.

### BRIEF DESCRIPTION OF DRAWINGS

FIG. 1 shows an isometric view of one embodiment of the invention.

FIG. 2 shows a side view of the embodiment of FIG. 1.

FIG. 3 shows a top view of the embodiment of FIG. 1.

FIG. 4 shows a sectional view of the embodiment of FIG. 3.

FIG. 5 shows a secondary sectional view of the embodiment of FIG. 3.

FIG. 6 shows a rear view of two embodiments of FIG. 1 mounted on a work surface, with a workpiece between them.

FIG. 7 shows a sectional view of the embodiment of FIG. 6. The right apparatus is shown before actuation while the left apparatus is shown fully actuated.

### DETAILED DESCRIPTION OF THE INVENTION

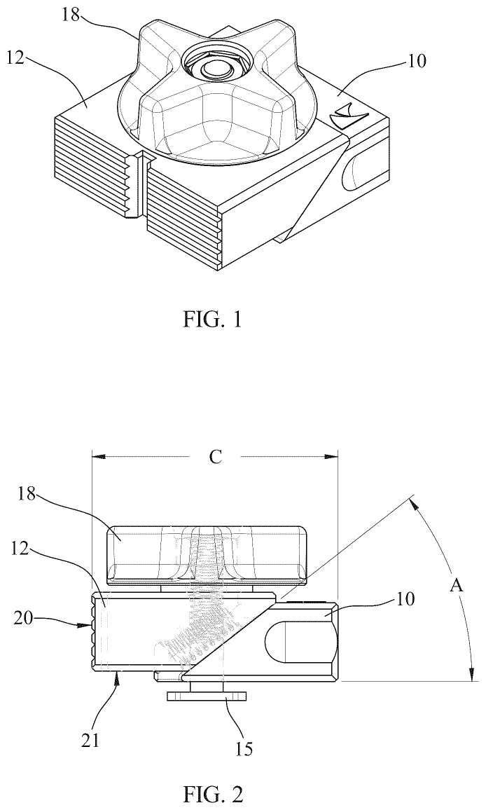

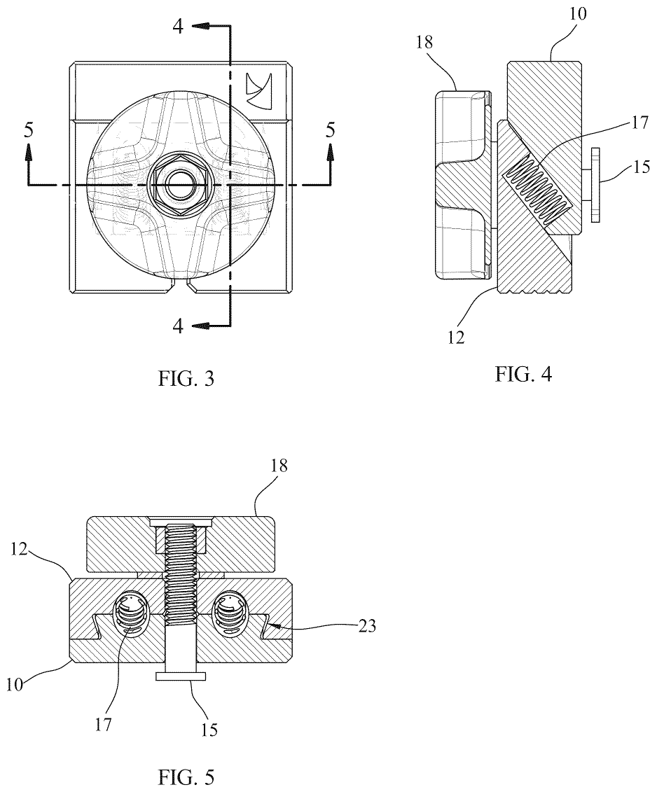

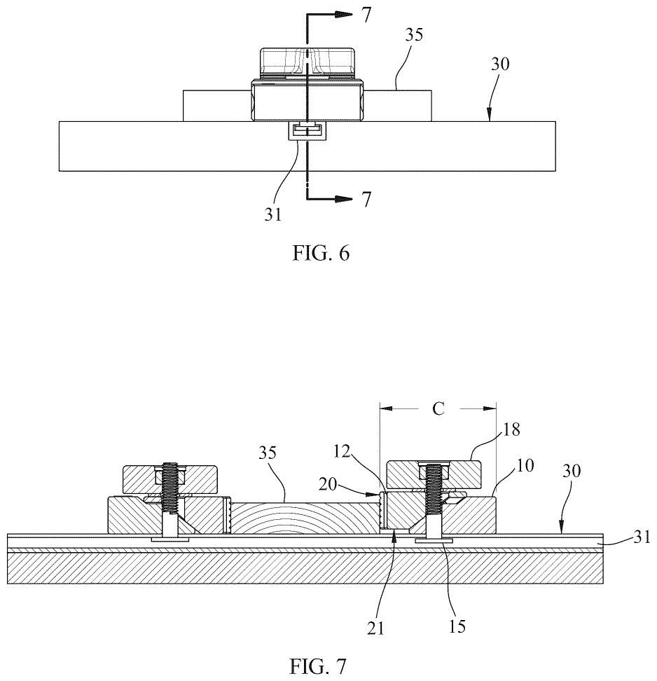

In one embodiment, as seen in FIG. 1, the invention comprises a base (10) and a jaw (12), wherein the jaw (12) may move linearly at angle A, shown in FIG. 2, relative to the base (10). Angle A may be any acute angle. In one preferred embodiment, angle A is about 40 degrees, and the sliding movement of the jaw relative to the base is constrained linearly at angle A by the dovetail way (23).

In this embodiment, a manually operated knob (18) is threaded onto the externally threaded end of T-bolt (15). Actuating the knob functions to both affix the base (10) to the work surface (30) and advance the jaw (12) linearly declined toward the workpiece (35).

In one embodiment compression springs (17) bear on the jaw (12) and the base (10) predisposing the jaw (12) to an upward position. This functions to position the jaw (12) in a ready state when the clamping knob (18) is released. In this state, the invention can be freely moved linearly along the T-channel (31), and rotationally about the T-bolt (15). Once the jaw (12) is in contact with the workpiece (35), actuating the clamping knob (18) will cause the T-bolt (15) to bear against the inner upper surface of the T-channel (31) and the upper surface of the jaw (12). An elongated slot through the jaw (12) provides clearance for the T-bolt (15) during movement of the jaw (12) relative to the base (10).

A secondary function of the springs (17) is to provide resistance to the movement of the jaw (12) relative to the base (10). This resistance functions to sequence the clamping action of the base (10) to the work surface (30) prior to the clamping action of the jaw (12) to the workpiece (35), i.e., prior to the increase of dimension C in FIG. 7.

FIG. 7 shows the primary gripping surface (20) on the jaw (12) remains perpendicular to the work surface (30) throughout the full range of motion, with the left embodiment shown fully actuated, and the right embodiment shown prior to actuation. When actuated the primary gripping surface (20) applies horizontal and vertical clamping forces to the workpiece (35).

In one preferred embodiment, a secondary gripping surface (21) on the jaw (12) remains parallel to the work surface (30) and can be used to engage the workpiece. In this embodiment, this secondary gripping surface would facilitate securing thinner material with a thickness of about 3 mm and under when a substantially vertical clamping force component is more suitable.

The present invention can be used without a dedicated work surface. The upper outer surface of the T-channel would replace the work surface in this embodiment.

1. A clamp apparatus for use with an elongated structural channel having a uniform
cross-section that has a longitudinal slot comprising an opening along the outer affixing surface and a widened opening internally to create an internal affixing surface, the apparatus comprising:
(a) a jaw assembly and a base, wherein the jaw may move toward the workpiece slidably mounted to the base along an inclined planer surface,
(b) a manually operable threaded element simultaneously affixes the base to the work surface and advances the jaw toward the workpiece,
(c) a spring, or plurality of springs, provides resistance to the jaw movement toward the workpiece, initiating the base-to-work surface affixing prior to the jaw-to-workpiece affixing.

2. A clamp apparatus wherein the jaw comprises two gripping surfaces permanently
configured to engage the workpiece either:
(a) with a primary compressive gripping force acting parallel to the work surface and a secondary frictional gripping force acting perpendicularly to the work surface,
(b) or with a primary compressive gripping force acting perpendicularly to the work surface and a secondary frictional gripping force acting parallel to the work surface, wherein:
i. the gripping surface perpendicular to the work surface remains perpendicular throughout the entire clamp actuation range, and in all longitudinal and rotational positions along the structural channel; and
ii. the gripping surface parallel to the work surface remains parallel throughout the entire clamp actuation range and in all longitudinal and rotational positions along the structural channel.
